(19) United States
(12) Patent Application Publication
(10) Pub. No.: US 2014/0342581 A1
(43) Pub. Date: Nov. 20, 2014

(54) VERTICAL MOUNT PCB COAXIAL CONNECTOR

(71) Applicant: Southwest Microwave, Inc., Tempe, AZ (US)

(72) Inventors: Clarence L. Clyatt, Goodyear, AZ (US); Robert Griffin, Tempe, AZ (US); Peter Frank, Carp (CA)

(73) Assignee: Southwest Microwave, Inc., Tempe, AZ (US)

(21) Appl. No.: 14/208,534

(22) Filed: Mar. 13, 2014

Related U.S. Application Data
(60) Provisional application No. 61/783,841, filed on Mar. 14, 2013.

(51) Int. Cl. H01R 12/75; H01R 43/16

(52) U.S. Cl. CPC H01R 12/75; H01R 43/16
USPC 439/63; 29/876

(57) ABSTRACT

A vertical mount PCB coax connector having a unique cavity design. The examples provide a vertical mounted connector with improved electrical performance to transmit a microwave signal to or from a coaxial port to planar printed circuitry. The vertical mount PCB connector includes a threaded housing with a four post flange for attachment to the PCB, a center conductor and a dielectric bead to support the center conductor. The bottom of the flange has a uniquely contoured cavity to provide air space for the electromagnetic field above the planar transmission line. Four posts at the corners of the flange serve as the ground connection from the connector to the substrate ground planes. The open or large cavity under the flange is designed to provide high values of inductive reactance at the high end of the microwave band and typically requires changing the planar geometry to achieve even a narrow band impedance match. This examples described have a reduced diameter cavity around the center conductor which, along with properly positioned via's on the PCB, tend to limit the inductive reactance and provide a broad band impedance match. This connector design can accommodate both stripline and grounded coplanar waveguide (GCPW).

### CROSS-REFERENCE TO RELATED APPLICATION

This application claims the benefit of U.S. Provisional Patent Application No. 61/783,841 filed Mar. 14, 2013, the contents of which are hereby incorporated by reference.

### TECHNICAL FIELD

This description relates generally to electrical connectors and more specifically to high frequency connectors.

### BACKGROUND

Vertical mounted printed circuit board (“PCB”) or equivalently printed wiring board (“PWB”) connectors appeared in microwave connector catalogs shortly after printed circuits came into use. A vertical mount SMA connector for stripline has been available since 1963 with adequate performance at the lower microwave frequencies. As improved substrates became available for use at higher microwave frequencies above 10 GHz, edge mounted connectors were often used and vertical mounted connectors saw little use. More recently printed circuits have become more complex and digital circuits have reaches speeds equivalent to the high microwave frequencies (40 GHz or more). Both analog and digital circuit designers need more flexibility in the positioning high frequency coaxial inputs, outputs and test ports. A need now exists for a vertical mounted connector with performance at least equal to the best edge mounted connector.

Vertical mounted connectors presently offered consist of basic four leg flange outer conductor and a center conductor that can be trimmed to fit by the customer. Circuit board modifications to improve the impedance match are also left to the customer.

Printed circuit board parameters will change with electrical and mechanical performance criteria; therefore one connector design will not accommodate all board sizes or materials. Given specific board parameters optimized for high microwave frequencies, a connector can be designed for excellent performance with specified board geometry. This will provide the customer with an economic advantage of a one trial design of a coaxial port to his planar circuit.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example of a vertical mount PCB connector provides a connector having a matched transition of a vertical mounted coaxial connector to a microstrip or coplanar waveguide transmission line on a printed circuit board.

The examples provide a vertical mounted connector with improved electrical performance to transmit a microwave signal to or from a coaxial port to planar printed circuitry. The vertical mount PCB connector includes a threaded housing with a four post flange for attachment to the PCB, a center conductor and a dielectric bead to support the center conductor.

The bottom of the flange has a uniquely contoured cavity to provide air space for the electromagnetic field above the planar transmission line. Four posts at the corners of the flange serve as the ground connection from the connector to the substrate ground planes. The open or large cavity under the flange is designed to provide high values of inductive reactance at the high end of the microwave band and typically requires changing the planar geometry to achieve even a narrow band impedance match. This examples described have a reduced diameter cavity around the center conductor which, along with properly positioned via's on the PCB, tend to limit the inductive reactance and provide a broad band impedance match. This connector design can accommodate both stripline and grounded coplanar waveguide (GCPW).

A major factor in achieving improved performance at higher frequencies is the contoured cavity cut into the flange. The reduced size allows the vias that short the top and bottom ground planes to make direct contact to the bottom of the connector flange tending to improve performance.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a first example of a typical PCB connector including a side view 118 and a bottom view.

FIG. 2 shows a second example of a typical PCB connector 20 of the kind known in the art as a mini SMP type.

FIG. 3 shows a first example of a specially designed vertical mount PCB coaxial connector having an impedance matching base.

FIG. 4 shows details of the impedance matching base.

FIG. 5 shows a top isometric view of the first example of a specially designed vertical mount PCB coaxial connector having an impedance matching base.

FIG. 6 shows a bottom Isometric view of the first example of a specially designed vertical mount PCB coaxial connector having an impedance matching base.

FIG. 7 shows a front view of the first example of a specially designed vertical mount PCB coaxial connector having an impedance matching base.

FIG. 8 shows a bottom view of the first example of a specially designed vertical mount PCB coaxial connector having an impedance matching base.

FIG. 9 shows a right side view of the first example of a specially designed vertical mount PCB coaxial connector having an impedance matching base.

FIG. 10 shows a left side view of the a first example of a specially designed vertical mount PCB coaxial connector having an impedance matching base.

FIG. 11 shows a second example of a specially designed vertical mount PCB coaxial connector having an impedance matching base and a 1.85 mm coaxial interface.

FIG. 12 shows a top isometric view of the second example of a specially designed vertical mount PCB coaxial connector having an impedance matching base.

FIG. 13 shows a bottom isometric view of the second example of a specially designed vertical mount PCB coaxial connector having an impedance matching base.

FIG. 14 shows a bottom view of the second example of a specially designed vertical mount PCB coaxial connector having an impedance matching base.

FIG. 15 shows a front view of the second example of a specially designed vertical mount PCB coaxial connector having an impedance matching base.

FIG. 16 shows a right side view of the second example of a specially designed vertical mount PCB coaxial connector having an impedance matching base.

FIG. 17 shows a left side view of the second example of a specially designed vertical mount PCB coaxial connector having an impedance matching base.

FIG. 18 shows an image of grounded coplanar waveguide (GCPW) layout for 8 mill thick RO4003 substrate of a printed wiring board.

FIG. 19 shows representative S Parameters of the connector shown in FIG. 3 that has been coupled to a PWB having the conductor layout shown in FIG. 1 8.

FIG. 20 shows an expanded view of the connector/substrate transition of the PWB.

FIG. 21 shows an expanded view of alternate connector/substrate transition of the PWB to reduce capacitance.

FIG. 22 shows an improved transition in a microstrip layout for 8 mil thick RO4003 substrate.

FIG. 23 shows the S Parameters of the connector (300 of FIG. 3) and the substrate layout of FIG. 22.

FIG. 24 is an image of an improved transition of a GCPW/microstrip with the connector of FIG. 3.

FIG. 25 shows the S Parameters for the improved transition of FIG. 24.

FIG. 26 shows measured data for the connector of FIG. 3 mounted on a PCB with the trace as shown in FIG. 18.

FIG. 27 shows measured data for the connector of FIG. 3 mounted on a PCB with the trace as shown in FIG. 18 but without the hole in the ground plane under the connector center pin.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The present example provides a connector having a matched impedance transition of a vertical mounted coaxial connector to a microstrip or coplanar waveguide transmission line on a printed circuit board.

The connectors described herein are often applied to circuitry operating at high frequencies, which may be termed radio frequency (“RF”) or microwave frequencies. It is understood that these are general terms not meant to limit the design to a specific band of frequencies (for example Ku band, X band, millimeter wave, or the like) unless specifically stated to do so, but rather merely indicative of the suitability of the examples described herein to use at higher frequencies.

As used herein microstrip transmission lines or simply “microstrip” is understood to mean a single signal conductor above a single ground plane, typically supported by a dielectric material that defines the characteristic impedance of the microstrip transmission lines calculated from parameters including the signal conductor width, height from the center conductor to the ground plane, and the dielectric constant of the dielectric material as is known to those skilled in the art.

Printed wiring boards with microstrip conductors may also include large areas of ground conductor on the signal conductor side with plated feed-through holes (“vias”) to couple the ground plane. Typically these ground areas on the center conductor side provide shielding and grounds for circuitry on that side of the printed wiring board.

Although the present examples are described and illustrated herein as being implemented in a connector having a matched transition of a vertical mounted coaxial connector to a microstrip or coplanar waveguide transmission line on a printed circuit board, the system described is provided as an example and not a limitation. As those skilled in the art will appreciate, the present examples are suitable for application in a variety of different types of transmission line systems.

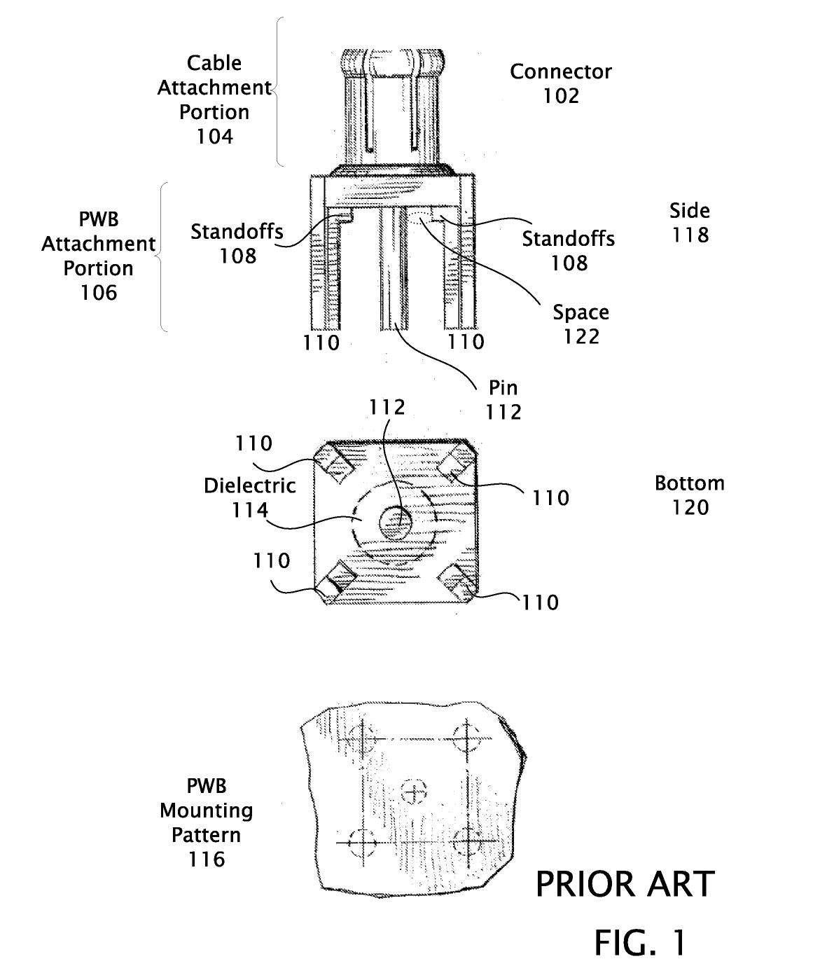

FIG. 1 shows a first example of a typical PCB connector 102 including a side view 118 and a bottom view 120. This particular connector type is known to those skilled in the art as a “straight PCB mount jack” of the MCX type. The majority of the connector vendors typically offer vertical mounted PCB connectors as shown. Aside from providing a mechanical transition it may be desirable to preserve the electrical qualities of a signal transitioning between a PWB and a cable. For example it may be desirable to provide a good match (as measured by S11, S22, return loss, or vswr), and to have low loss (as measured by S21, S12, and the like). In many conventional connectors good signal properties may be provided by good grounding and shielding techniques. However as signal frequency increases these conventional transition designs may be inadequate.

A conventional connector 102, may include an cable attachment portion 104 where an external connection (typically to a 50 or 75 ohm cable) through a mating connector (not shown) may be made. The connector 102 may include a printed circuit board (“PCB”) attachment section 106 that couples the connector to the electrical ground and signal traces of a PCB (or alternatively printed wiring board PWB) upon which the connector 102 is disposed. The printed wiring traces are typically designed to have a characteristic impedance of 50 or 75 ohms, although any desired characteristic impedance may be provided.

The connector typically has its exterior surface tied to, electrical ground. The center pin 112 carries the signal that may be coupled to a PCB trace (not shown). In making the transition from the pin 112 to the trace, care must be taken in the design to prevent shorting the signal to the PCB ground plane (not shown) that is typically present in good radio frequency (RF) and microwave designs. The hole pattern for mechanical mounting of connector 102 to the PWB 116 is shown. To prevent shorting a space 122 is often provided between the connector body and the PWB 116 to which the connector will be disposed.

A standoff 108 may be included on all four posts as a spacer to prevent shorting the PCB signal line 112 to ground (the connector body and posts 110). The four posts 110 are the ground connection to PCB however the space provided by the standoffs 108 is typically more than ¼ of a wavelength above 15 GHz which may cause signal leakage or the undesired launch a surface wave on the PCB. As can be seen in this design there is nothing particularly done in the way of impedance matching between the cable attachment portion 104 and the PCB attachment portion 106 to preserve signal characteristics at this discontinuity, or transition.

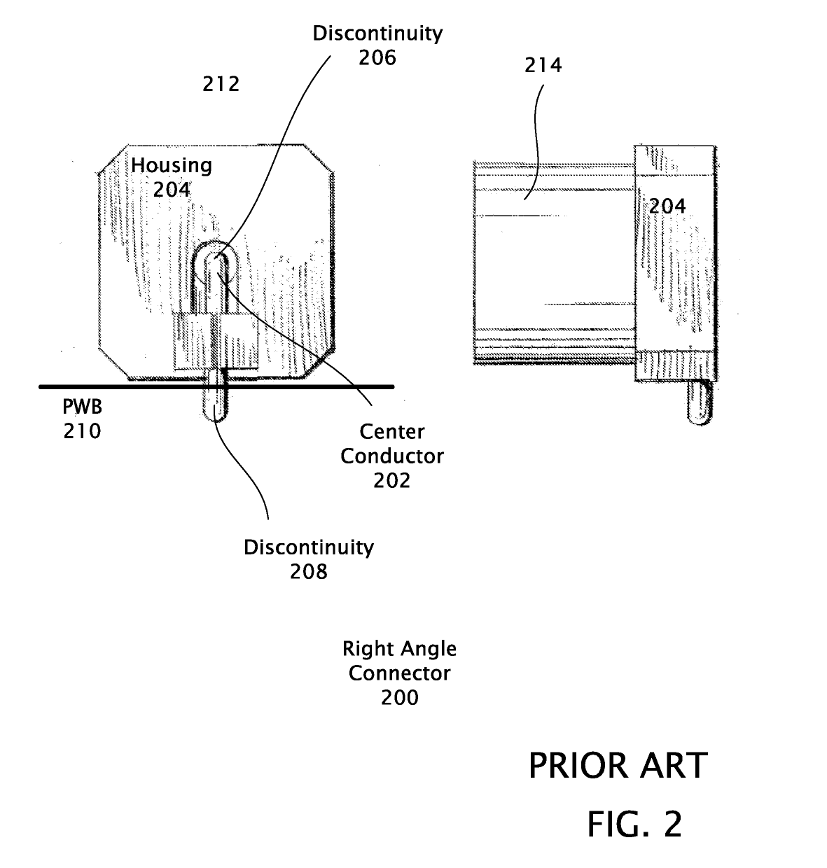

FIG. 2 shows a second example of a typical PCB connector 200 of the kind known in the art as a mini SMP type. An rear view 212, and a side view are shown. This is a top mounted connector housing 204 with the center conductor 202 making a right turn at the bottom of the housing and exiting through the side and becomes an end launch transition to the printed circuit. This design then has two impedance discontinuities, one at the right angle 206 and another at the center conductor attachment 208 to the PCB 210 and is thus more difficult to impedance match.

The poor impedance match is evident in the poor return loss numbers typically published above 25 GHz cited in the manufactures catalog for this type of connector. Both of these connector types described above 200, 102 (of FIG. 1) do not provide Impedance matching as part of the connector structure. Impedance matching as part of the connector design would be desirable in improving electrical performance at existing specified frequencies of operation, as well as extending the frequency of operation in electrical high frequency connectors. Applicants have designed a unique stepped cavity under the connector to transition impedances and also that allows ground feed through distances in a printed wiring board coupled to the connector to be minimized as in the vertical mount PCB connector.

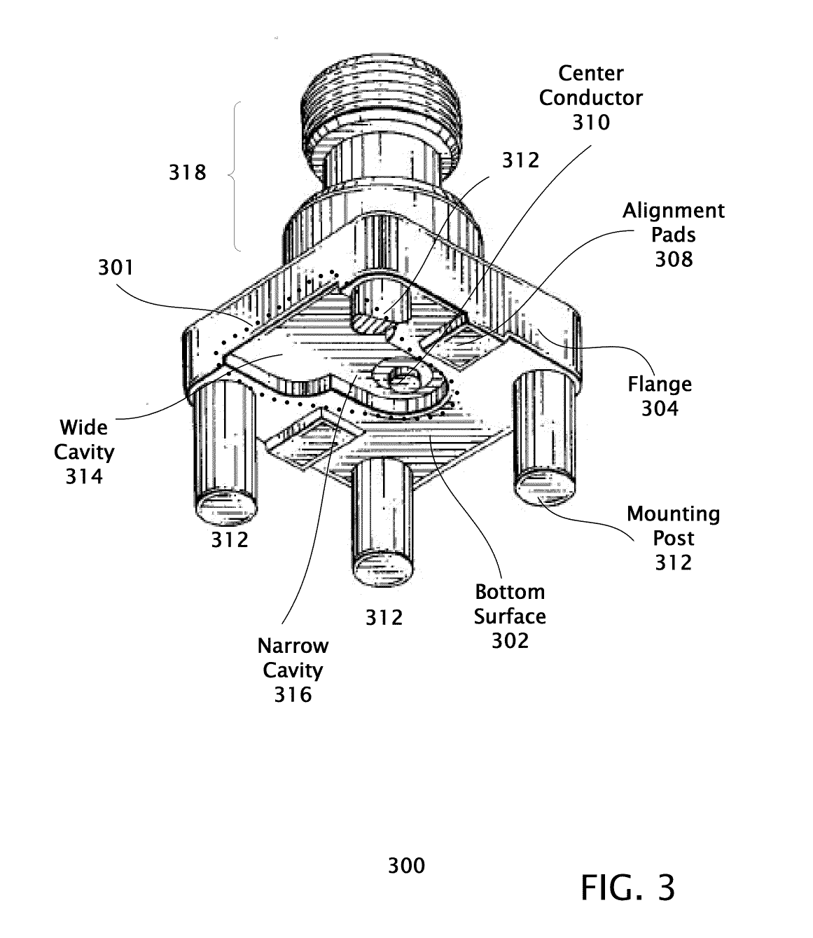

FIG. 3 shows a first example of a specially designed vertical mount PCB coaxial connector having an impedance matching base 300. The isometric view shows the unique impedance matching construction of the vertical mount PCB connector 300.

The vertical mount PCB connector includes a unique contoured cavity 301 cut into the flange 304. The contoured cavity 301 provides air space above the signal line when the vertical mount PCB connector 300 is attached to the top of a planar transmission line (not shown). The contoured shape shown of the cavity is exemplary. For equivalent electrical performance in impedance matching rectangular, square or trapezoidal shapes may be utilized. The rounded corners shown tends to aid is a machining convenience. The flange bottom surface 306 contacts the top ground plane of the PCB (not shown) and tends to contain the electromagnetic field within the enclosed structure.

The examples described herein provide a vertical mount PCB connector with improved electrical performance to transmit a microwave signal to or from a coaxial port to planar printed circuitry. The vertical mount connector includes a threaded housing 318 with a four post flange 304 for attachment to the PCB (not shown), a center conductor 310 and a dielectric bead to support the center conductor. The bottom of the flange has a contoured cavity 301 to provide air space for the electromagnetic field above the planar transmission line. The coaxial interface 318 illustrated in FIG. 3 is a SSBT size 20; however any 50 ohm interface can be used if the size is consistent with high microwave frequencies.

Two alignment pads 308 will tend to improve the precision of the center conductor 310 alignment with a mating PCB conductor pad (not shown) that is disposed upon the PCB. Standard dimensional tolerances on the four mounting posts 312 may exceed the desired alignment for high microwave frequency performance. Accordingly, care must be taken in the layout and drilling of these mounting holes, and the construction of the posts 312. Four posts 312 at the corners of the flange serve as the ground connection from the connector to the substrate ground planes on the PWB (not shown).

A specially designed cavity structure 301 cut into the flange 304 tends to provide a somewhat broad band impedance match where the PWB trace (not shown) couples to a center pin or conductor 310 of the connector 300. The open or large cavity 314 on the bottom side of the flange 304 may lead to high values of inductive reactance at the high end of the microwave band and may require changing the planar geometry to achieve even a narrow band impedance match.

The impedance match is further aided by the reduced diameter cavity 316 around the center conductor 310 which, along with properly positioned via holes between ground planes on the PCB, will tend to limit the inductive reactance at the discontinuity and provide a broad band impedance match over frequency. This connector design can accommodate both stripline and grounded coplanar waveguide (GCPW). The depth of the cavity cut into flange 304 in the example described below is nominally 0.0255 inches deep.

The feature that tends to allow improved performance at higher frequencies is the contoured cavity 301 cut into the flange. The reduced size 316 additionally allows the vias that short the top and bottom ground planes of the PWB (not shown) to make direct contact to the bottom of the connector flange 304. This structure optimally allows matching coaxial connectors to other transmission media by making the ground connections as short as possible. It is further worth noting that the matching structure 301 incorporated in the flange 304, may be incorporated into a variety of coaxial connector interfaces, as desired.

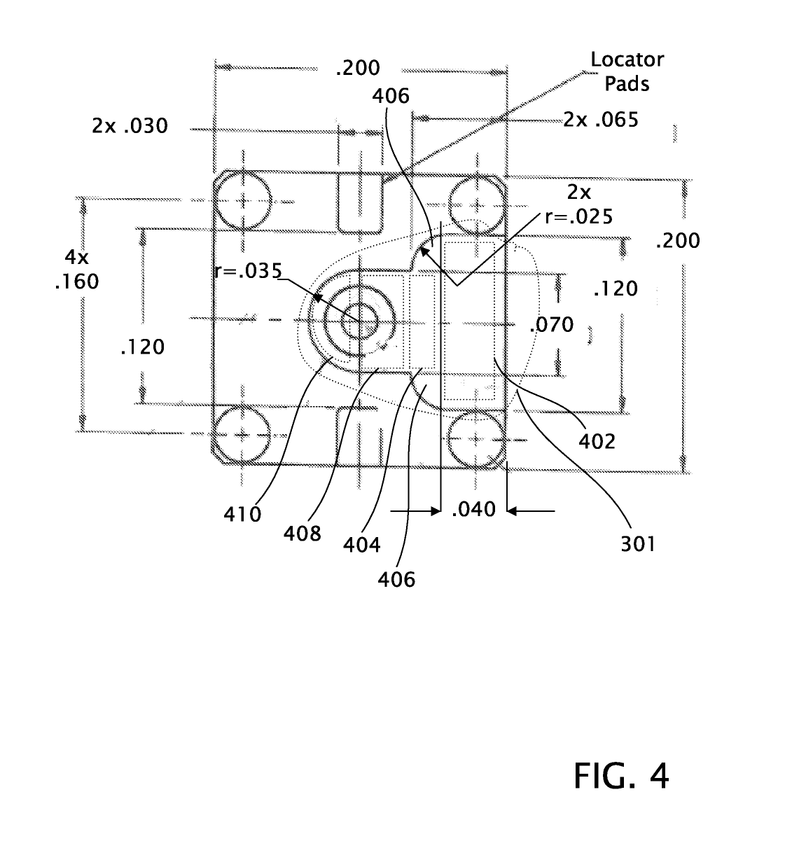

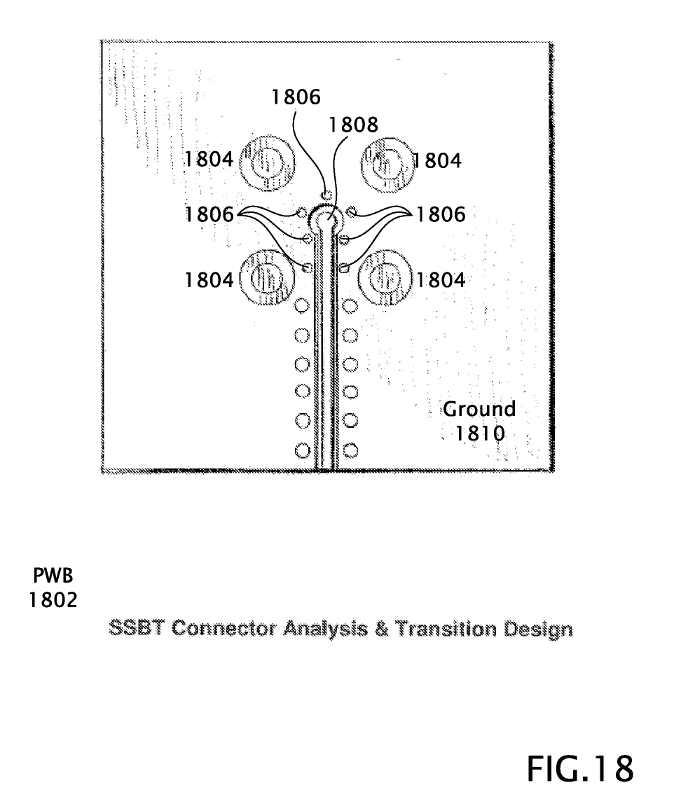

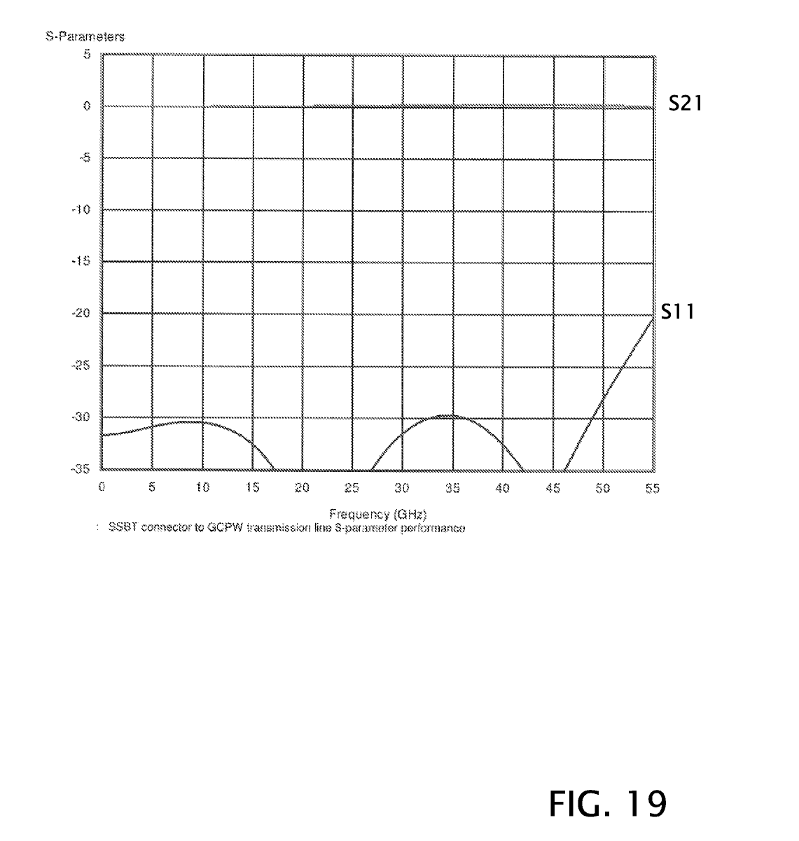

FIG. 4 shows details of the impedance matching base. The cavity 301 dimensions shown provide the performance as shown in FIG. 19, when utilizing the PWB conductor pattern shown in FIG. 18.

In this example the wide cavity 314 includes a first rectangular region 402 nominally 0.120 inches wide and 0.040 inches deep. Adjoining it, and centered about its width is a second rectangular region 404 0.070 inches wide and substantially 0.025 inches deep, and having two substantially quarter circle radiused areas 406 between the first rectangular region 402 and the second rectangular region 404, where the radiuses are nominally 0.025 Inches.

The reduced diameter cavity 316 includes a third rectangular region 408 0.070 inches wide centered about her first and second rectangular regions 402, 404. The third rectangular region 408 is adjacent a semicircular region 410 of substantially a radius of 0.035 inches. The distance from the edge of the third rectangular region adjacent to the semicircular region to the outside or distal edge of the first rectangular region is substantially 0.100 inches.

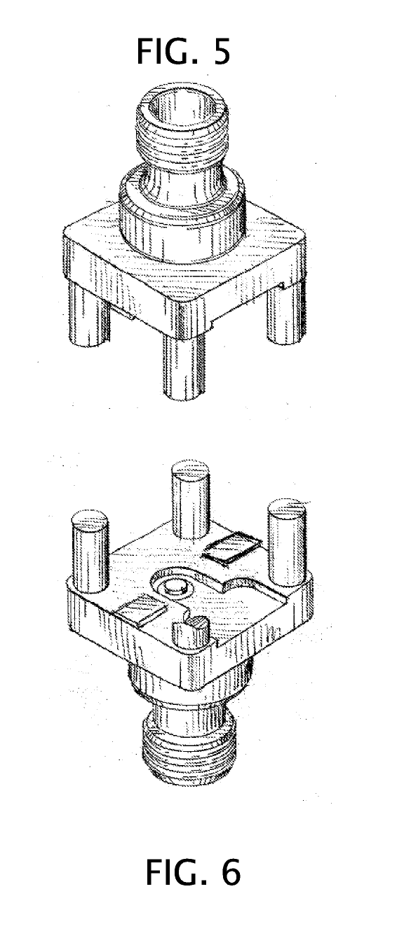

FIG. 5 shows a top isometric view of the first example of a specially designed vertical mount PCB coaxial connector having an impedance matching base.

FIG. 6 shows a bottom Isometric view of the first example of a specially designed vertical mount PCB coaxial connector having an impedance matching base.

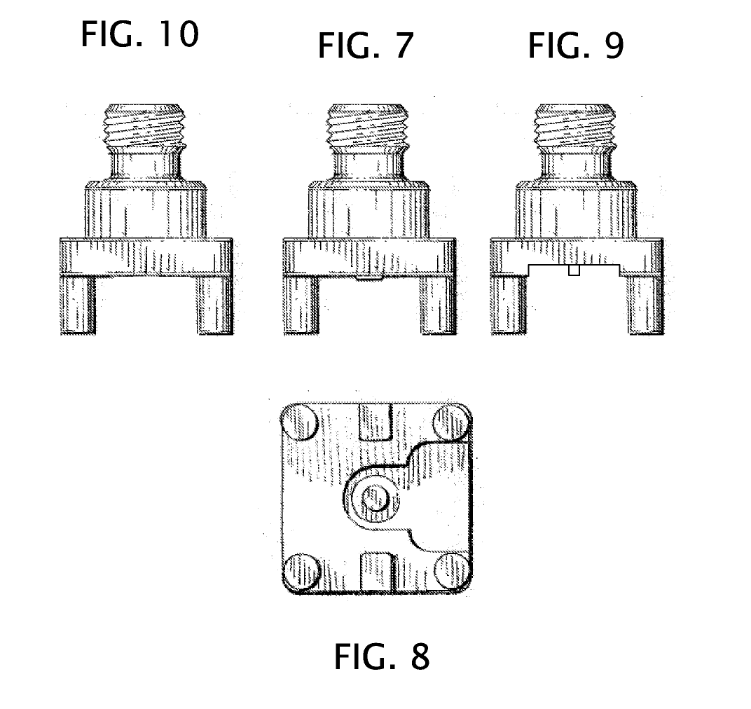

FIG. 7 shows a front view of the first example of a specially designed vertical mount PCB coaxial connector having an impedance matching base.

FIG. 8 shows a bottom view of the first example of a specially designed vertical mount PCB coaxial connector having an impedance matching base.

FIG. 9 shows a right side view of the first example of a specially designed vertical mount PCB coaxial connector having an impedance matching base.

FIG. 10 shows a left side view of the a first example of a specially designed vertical mount PCB coaxial connector having an impedance matching base.

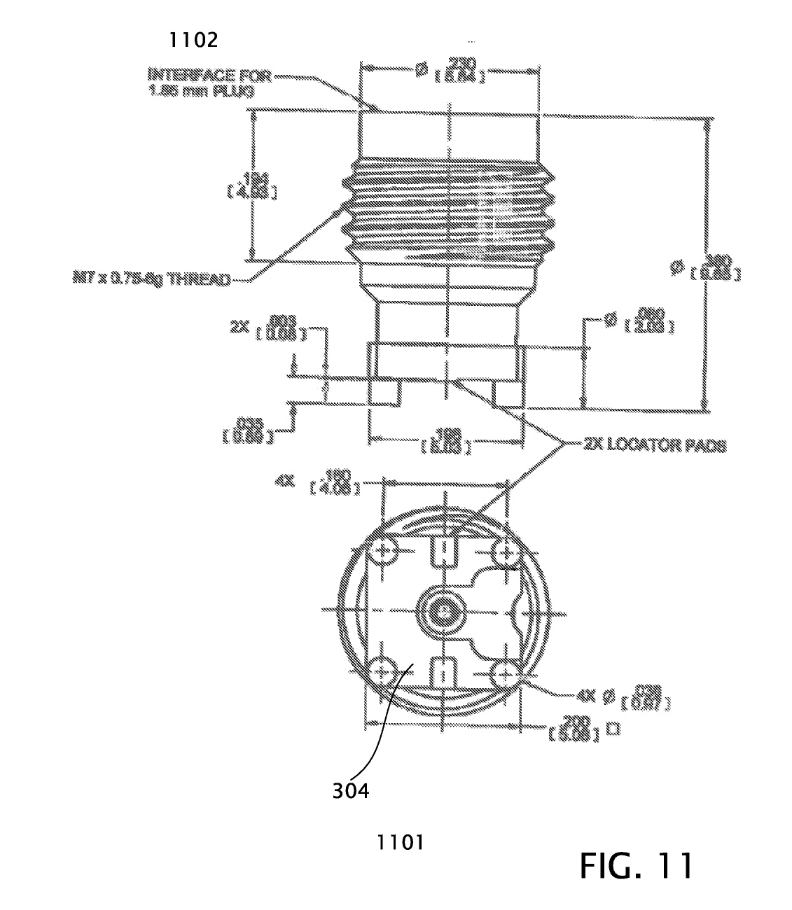

FIG. 11 shows a second example of a specially designed vertical mount PCB coaxial connector having an impedance matching base with a 1.85 mm coaxial interface 1101. This connector example includes the flange 304 with the cavity proportions as previously described. However, this example provides an interface for a 1.85 mm plug 1102 as an example of the various interfaces that may be provided.

The 1.85 mm interface is useful through 67 GHz. Larger diameter connector interfaces may be step matched by conventional techniques into the 50 ohm line. This tends to limit high frequency performance, but may allow standardization of connectors with the PCB etch patterns and provide better low frequency performance.

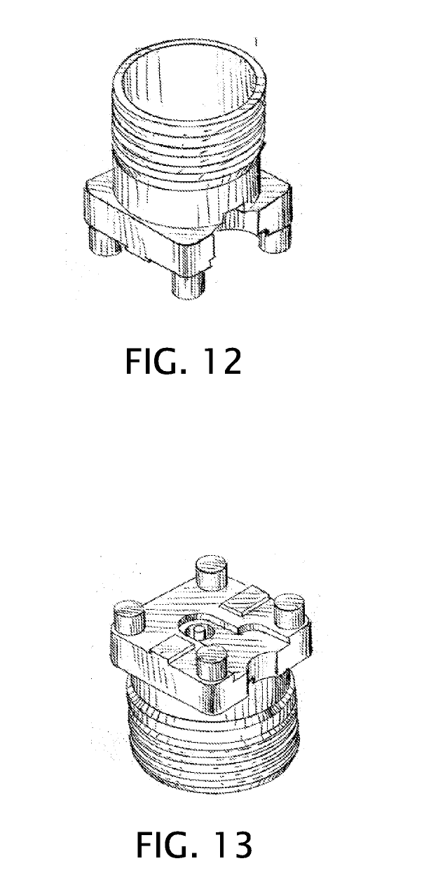

FIG. 12 shows a top isometric view of the second example of a specially designed vertical mount PCB coaxial connector having an impedance matching base.

FIG. 13 shows a bottom isometric view of the second example of a specially designed vertical mount PCB coaxial connector having an impedance matching base.

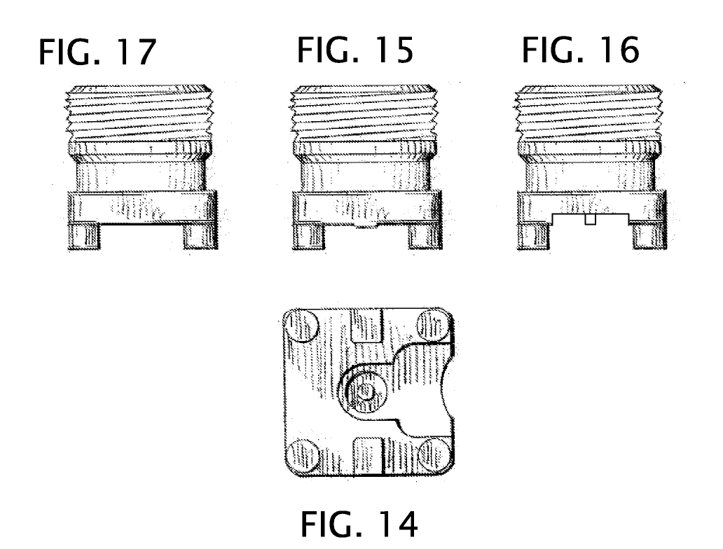

FIG. 14 shows a bottom view of the second example of a specially designed vertical mount PCB coaxial connector having an impedance matching base.

FIG. 15 shows a front view of the second example of a specially designed vertical mount PCB coaxial connector having an impedance matching base.

FIG. 16 shows a right side view of the second example of a specially designed vertical mount PCB coaxial connector having an impedance matching base.

FIG. 17 shows a left side view of the second example of a specially designed vertical mount PCB coaxial connector having an impedance matching base.

FIG. 18 shows an image of GCPW layout for 8 mill thick RO4003 substrate of a printed wiring board 1802. A top view of the board 1802 is shown that includes the signal trace 1808, and the top ground plane 1810. There are four plated holes 1804 to accommodate the connector posts (312 of FIG. 3) that will be disposed therein. There are also seven 6 mil via holes 1806 coupled to ground that will be positioned under the connector (300 of FIG. 3) once it is disposed upon the PWB 1802.

This exemplary PWB may be made of, Rogers RO4003® having the following characteristics: substrate. RO4003 is a glass reinforced hydrocarbon/ceramic laminate, dielectric constant 3.38, a loss tangent of 0.0027, 0.0005 inch thick copper on both sides, and a total thickness of 0.008 inches.

This etch pattern tends to be an optimized PC top ground plane pattern for use with the connector (300 of FIG. 3). The a PWB with the ground pattern shown, when coupled to the vertical mount PCB connector creates a connector or impedance transition system between a cable (such as a coaxial cable) and a printed wiring board. The plurality of via holes 1806 to ground that will be positioned under the connector flange are positioned in a circular arrangement around the connector center conductor. The diameter of the outer conductor will determine if modes other than TEM can exist in the transition region. The equation for determining the wavelength of the next higher coaxial mode (TE11) is:

λc=(D+d)π/2

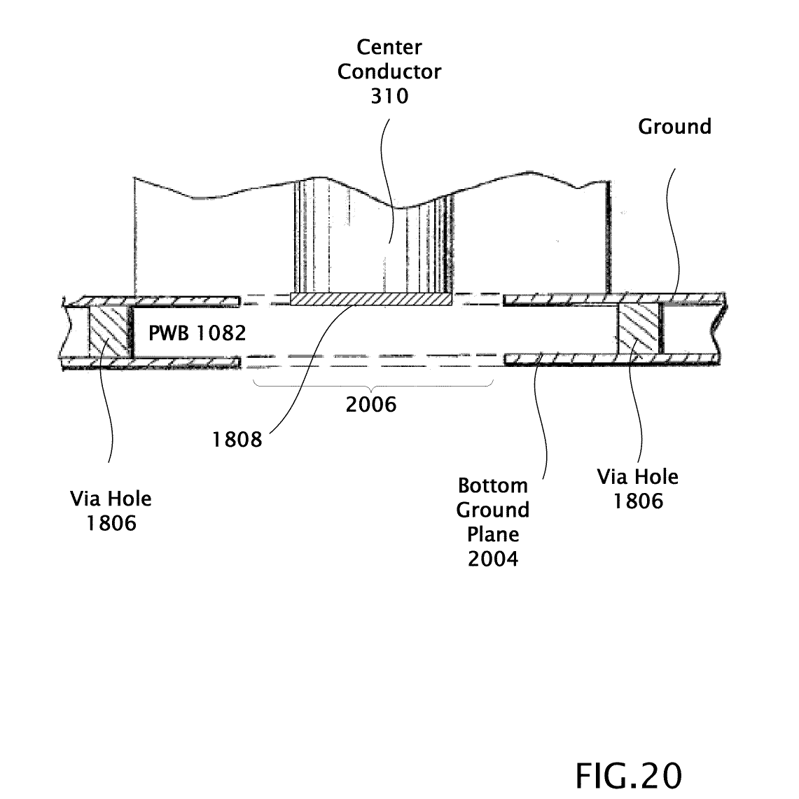

This is an approximation, accurate typically within 3% of a more accurate numerical solution and it shows there will be no higher modes supported below 80 GHz in the air filled connector 0.070 diameter cavity. The ring of vias has an exemplary diameter of 0.0790 and may be filled with exemplary RO4003 and dielectric constant of 3.38. This substantially forms a circular waveguide cavity where the TE11 mode cutoff wavelength is: λc=D/2√∈3.412 and λc=49 GHz and is within the frequency band of interest. A small hole or aperture etched or otherwise formed in the bottom ground plane centered under the center conductor (as shown in cross sectional view of FIG. 20) will typically reduce the effective dielectric constant and raise the TE11 cutoff frequency above 50 GHz.

FIG. 19 shows representative S Parameters of the connector shown in FIG. 3 that has been coupled to a PWB having the conductor layout shown in FIG. 18. The S parameters, or scattering parameters, are shown from DC to 55 GHz with a ground plane hole. Return loss S11 is typically greater than −20 dB across the band. S11 starts to increase at frequencies above 40 GHz. The transmission loss S21 is for the most part negligible, but increasing as frequency increases. The combined GCPW circuitry pattern (1802 of FIG. 18) under the connector flange (304 of FIG. 3) that transitions to microstrip at the edge of the flange shows improved performance in the 40 to 50 GHz band.

The factor in achieving improved performance at higher frequencies is the contoured cavity (301 of FIG. 3) cut into the flange. The reduced size allows the via holes, that short the top and bottom ground planes to make direct contact to the bottom of the connector flange. This aids matching coaxial connectors to other transmission media by making the ground connections as short as possible.

Where a circuit module or “package” design utilizes stacked PC boards or a shielded enclosure, the ground plane hole may employ a thin layer of air space below the hole. The extra cost and complexity may be prohibitive and an alternate design is suggested. The center conductor of the connector can be tapered from the exemplary 24 mill diameter to 14 mil with the etched trace to match. This will tend to reduce the parallel plate capacitance and raise the inductive reactance of the air cavity. The top ground plane hole can now be optimized for 50 ohms or the lowest return loss for the transition.

FIG. 20 shows an expanded view of the connector/substrate transition of the PWB 1802. A cross section of the expanded transition with the bottom ground plane hole 2006 in the bottom ground plane 2004 is shown. The center conductor 310 of the connector (300 of FIG. 3) is coupled to the signal trace 1808. The plated through via holes 1806 electrically couple the top ground foil 1810 to the bottom ground plane 2004.

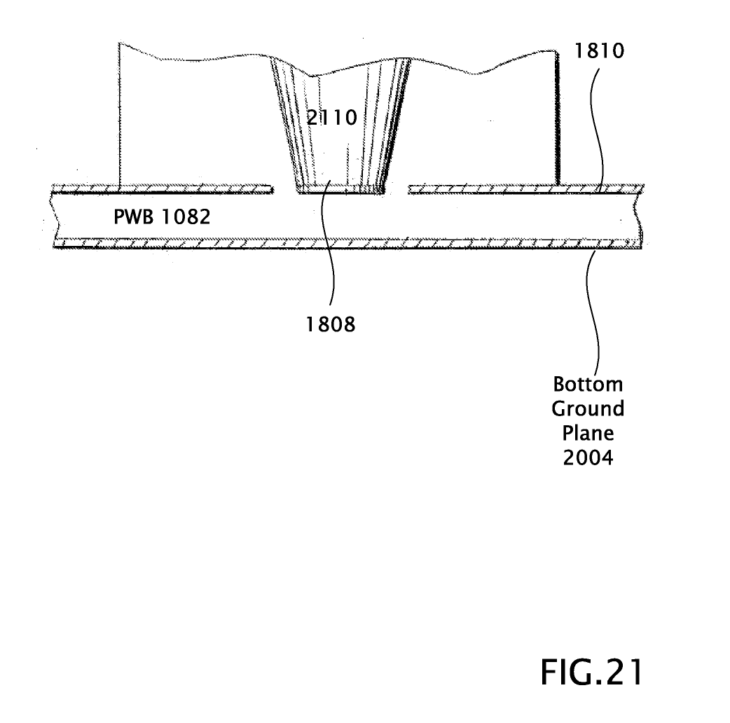

FIG. 21 shows an expanded view of alternate connector/substrate transition of the PWB 1802 to reduce capacitance. In this example the center conductor 2110 of the connector (300 of FIG. 3) has been altered as it is conical in shape to reduce its diameter where it contacts the PWB 1802. Pin 2110 is coupled to a signal trace 1808 that has been reduced in area to match the pin diameter at the point of contact reducing its capacitance as well. In this example the hole in the ground plane 2004 of the previous example is absent.

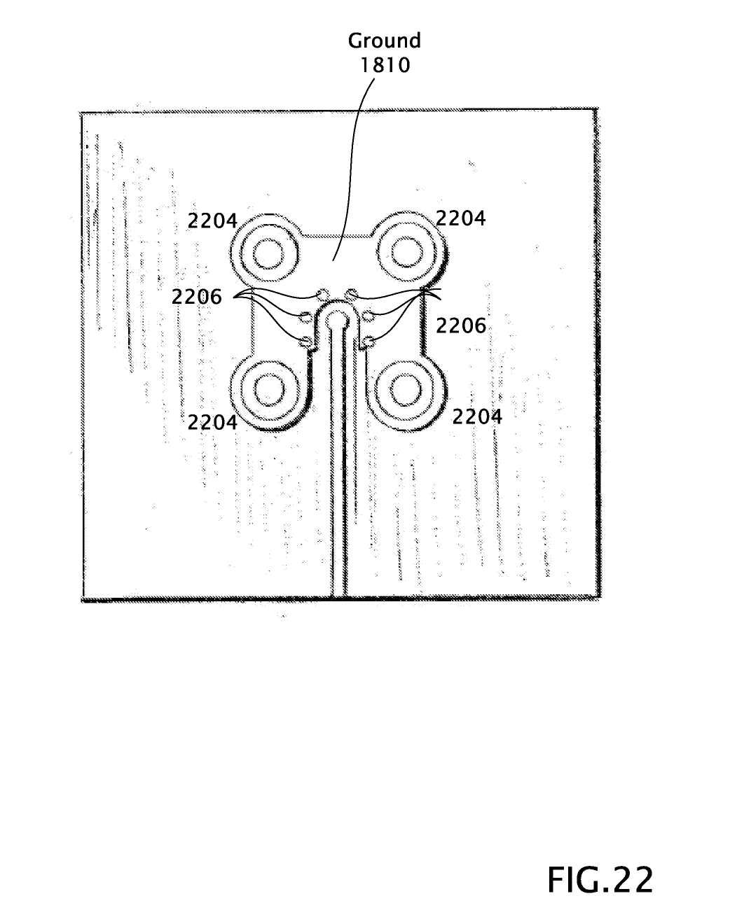

FIG. 22 shows an improved transition in a microstrip layout for 8 mil thick RO4003 substrate. There are four plated holes for the connector posts 2204 and six via holes 2206 under the connector flange.

The simulated results for the S parameters is FIG. 9 show low values of S11 through 30 GHz and then increasing with higher frequency. The performance can be improved by making use of the GCPW transition shown in FIG. 4 and then changing to microstrip mode at the edge of the flange as shown in FIG. 10. The simulated optimized performance is given in FIG. 11.

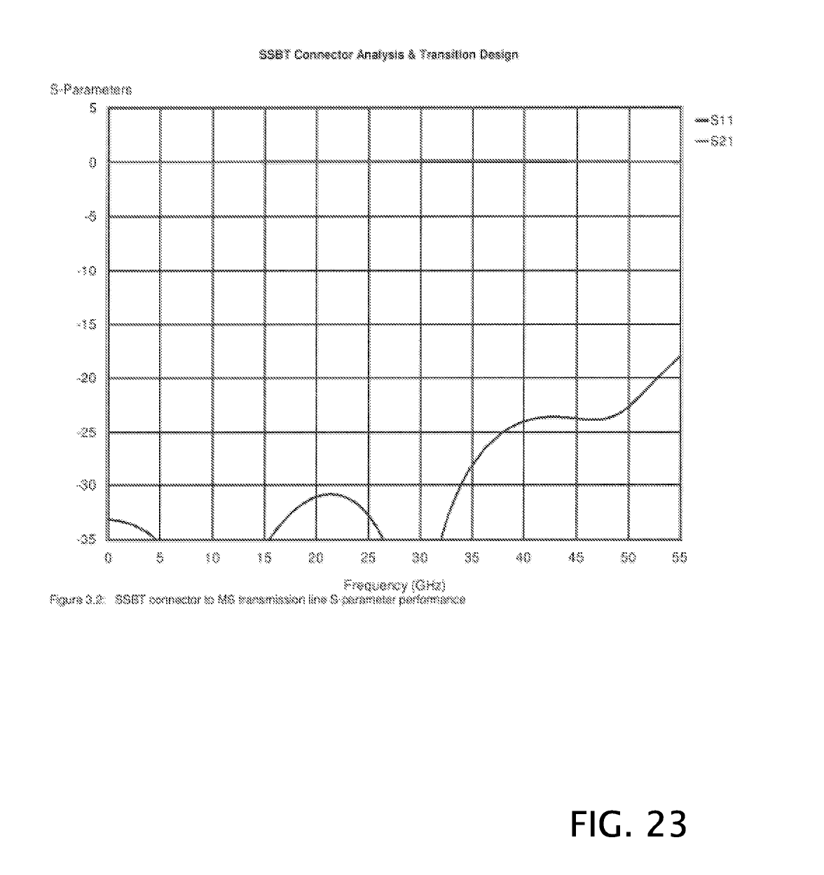

FIG. 23 shows the S Parameters of the connector (300 of FIG. 3) and the substrate layout of FIG. 22. The plot shows low values of S11 through 30 GHz and then increasing with higher frequency.

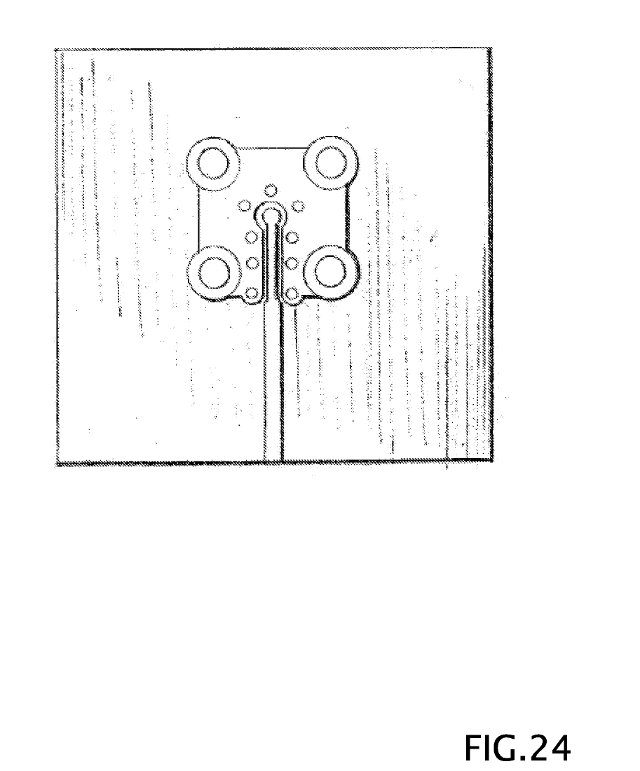

FIG. 24 is an image of an improved transition of a GCPW/microstrip with the connector of FIG. 3. Performance can be improved by making use of the GCPW transition shown in FIG. 18 initially, and then changing to microstrip mode at the edge of the flange as shown in FIG. 24.

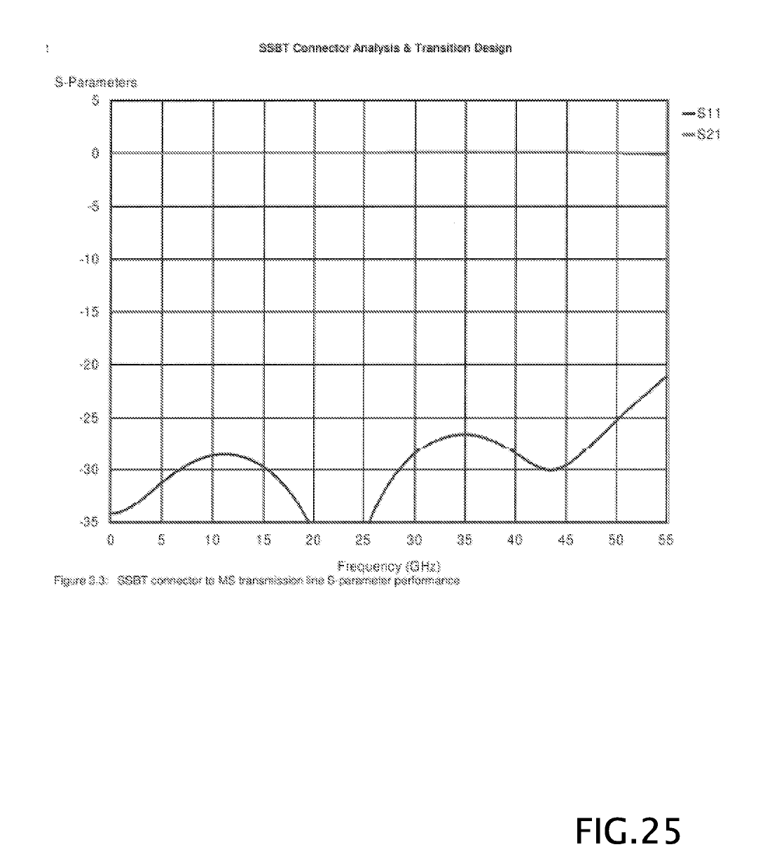

FIG. 25 shows the S Parameters for the improved transition of FIG. 24. S21 is negligible, and the return loss is below 20 dB for the frequency range of 0 to 55 GHz shown.

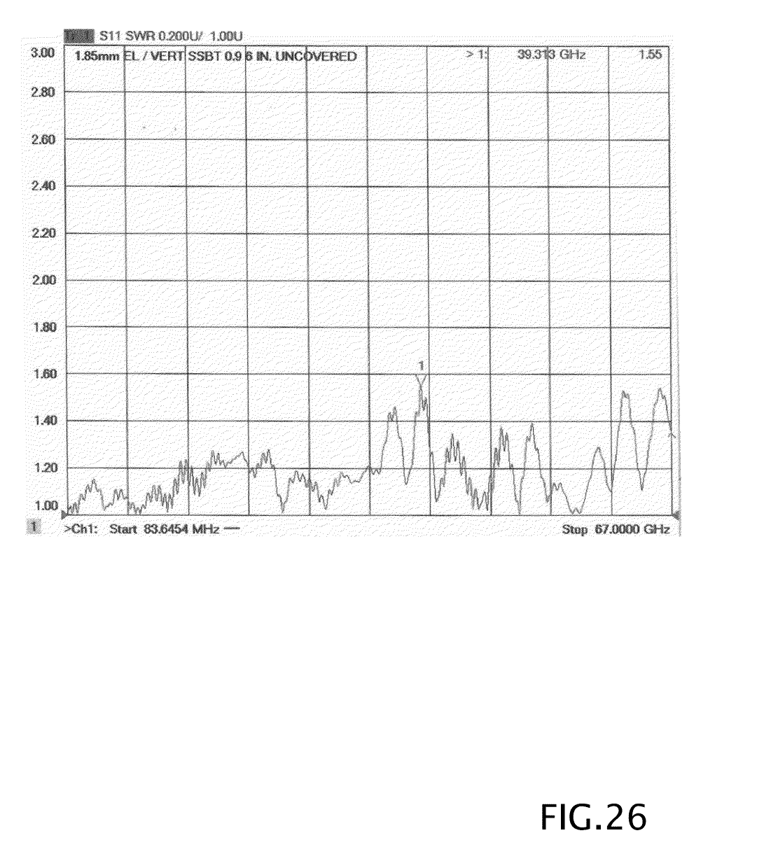

FIG. 26 shows measured data for the connector of FIG. 3 mounted on a PCB with the trace as shown in FIG. 18. This is a vector network analyzer screen of VSWR from 83 MHz to 67 GHz. The measurement includes the vector addition of discontinuities from the vertical mounted connector of FIG. 3, the microstrip (50 ohm) PCB and an edge mount connector with a 50 ohm termination. The cyclic pattern with deep nulls down to values near 1.00 is typical of two nearly equal discontinuities separated be a long transmission line. This condition allows the square root of the peak values to indicate the separate values of the two discontinuities. Therefore the square root of the peak 1.55 vswr becomes 1.24 max value for the vertical mount connector.

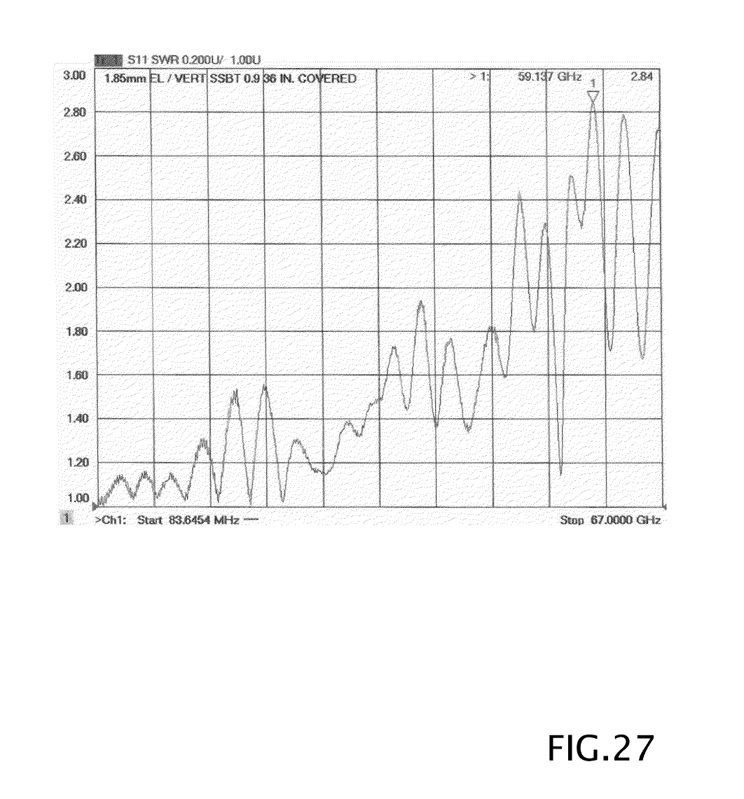

FIG. 27 shows measured data for the connector of FIG. 3 mounted on a PCB with the trace as shown in FIG. 18 but without the hole in the ground plane under the connector center pin. The vswr peak rises to 2.84 with increasing frequency. The absence of the hole adds parallel capacity and lowers the transmission line impedance well below 50 ohms which tends to account for the higher vswr.

Those skilled in the art will realize that the process sequences described above may be equivalently performed in any order to achieve a desired result. Also, sub-processes may typically be omitted as desired without taking away from the overall functionality of the processes described above.

1. A vertical mounted printed circuit board (PCB) coaxial connector comprising:
a center conductor supported by a solid dielectric, an outer conductor and a flange for coupling to a PCB the flange including on a bottom side:
a plurality of posts for positioning the coaxial connector on the PCB;
a first cavity in a bottom of the flange around the center conductor; and
a second cavity having a width greater than a width of the first cavity and adjoining it on a first side, and having a second side adjoining an edge of the flange
whereby, the dimensions of the coax diameters and the flange cavity are predetermined to optimize microwave performance up to 50 Ghz.

2. The vertical mounted printed circuit board (PCB) coaxial connector of claim 1 further comprising a first alignment pad and a second alignment pad to permit precise alignment of the center conductor with a PCB trace.

3. The vertical mounted printed circuit board (PCB) coaxial connector of claim 1 in which a height of the first and second cavities is the same.

4. The vertical mounted printed circuit board (PCB) coaxial connector of claim 1 in which corners of the second cavity on the first side adjoining the first cavity are rounded.

5. A high frequency connector comprising:
a cable attachment portion; and
a PCB attachment portion coupled to the cable attachment portion including:
a flange having a cavity of uniform height cut into a bottom surface of the flange, and around an area where a center conductor pin extends from the flange, and with the cavity widening as the cavity extends through a flange edge.

6. The A high frequency connector of claim 5 further comprising a plurality of alignment pads on the bottom surface of the flange for use in precisely maintaining alignment of the center conductor to a mating signal line.

7. The A high frequency connector of claim 1 in which the flange around the area where the center conductor pin extends from the flange provides grounding near the center conductor pin.

8. The A high frequency connector of claim 1 further comprising a plurality of mounting posts for mechanical stability in mounting the connector and providing a ground connection to circuitry coupled to the connector.

9. The A high frequency connector of claim 1 in which impedance matching to circuitry coupled to the connector is provided by the cavity.

10. A method of making a high frequency connector comprising:
forming a cable attachment portion;
forming a flange portion extending from the cable attachment portion; and
forming a stepped cavity of uniform height in a bottom surface of the flange.
